(19) United States
(12) Patent Application Publication
(10) Pub. No.: US 2004/0178385 A1
(43) Pub. Date: Sep. 16, 2004

(54) Method for preparing a composite solid material based on hexacyanoferrates, and method for fixing mineral pollutants using same

(76) Inventors: Isabelle Bispo, Paris (FR); Slobodan Milonjic, Beograd (FR)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/486,829

(22) PCT Filed: Aug. 20, 2002
(86) PCT No.: PCT/FR02/02906

(30) Foreign Application Priority Data
Aug. 22, 2001 (FR) 0111005

(51) Int. Cl. C02F 5/02; C09K 3/00; B32B 27/00

(52) U.S. Cl. 252/175; 252/182.32; 428/473.5

(57) ABSTRACT

Process for the preparation of a composite solid material which fixes inorganic contaminants, based on metal hexacyanoferrate, comprising a solid support coated with a film of an anion-exchange polymer to which is fixed an insoluble metal hexacyanoferrate forming a thin layer, said process essentially comprising at least one step in which said solid support is brought into contact with at least one liquid reactant and at least one step in which washing is carried out with a washing liquid, characterized in that all of the steps of the process are carried out continuously in one and the same receptacle, such as a column, in which the support forms a fluidized bed, the fluidization of which is provided by said at least one reactant or washing liquid.

### DESCRIPTION

The present invention relates to a process for the preparation of a composite solid material based on insoluble hexacyanoferrates, which fixes inorganic contaminants.

More specifically, the present invention relates to a process for the preparation of a composite solid material which fixes inorganic contaminants, based on hexacyanoferrates and on cationic polymers, which are deposited as a film layer on a support. More specifically still, the present invention relates to a process for the preparation of a composite solid material which fixes inorganic contaminants formed of a solid support, mechanically and chemically stable, coated with a film of an anion-exchange polymer to which is fixed a thin layer of insoluble hexacyanoferrate.

The present invention also relates to a process for fixing at least one inorganic contaminant, present in a solution, to said composite solid material which fixes inorganic contaminants.

Numerous inorganic fixing agents have been used for the fixing of various inorganic contaminants, such as metal cations, present in various media and effluents resulting from various industries and in particular from the nuclear industry.

This is because the nuclear industry uses, for the treatment of slightly or moderately radioactive effluents, purification techniques with reduction in volume which consist of the fixing to an inorganic solid of the radioisotopes present in the solutions. The volumes currently treated are huge and reach several tens of thousands of m³/year for France. The liquids treated are also varied in nature since it is a matter equally well of treating the cooling water from nuclear power stations as the various effluents which come into contact with radioisotopes, such as all aqueous washing solutions, solutions from the regeneration of resins, and the like.

Hexacyanoferrates, in particular Cu, Ni and Co hexacyanoferrate(II), are among the most commonly used inorganic fixing agents, in particular in the nuclear industry, because of the high affinity which they have with respect to caesium. Inorganic fixing agents of hexacyanoferrate type have therefore been used in particular to separate, recover and fix metal ions and in particular ions of radioactive alkali metals, such as caesium-137, with a long half life from various industrial and nuclear effluents, for example from the highly acidic solutions resulting from the reprocessing of irradiated fuels and from the solutions already mentioned above.

Currently, insoluble hexacyanoferrates thus participate in the majority of the processes for treating liquid radioactive wastes by coprecipitation.

The document FR-A-2 765 812 discloses the method of preparation and of use in a column of a material composed of metal hexacyanoferrate fixed to a solid support, chemically and mechanically stable, coated with a thin film of anion-exchange organic polymers for the fixing of at least one inorganic contaminant, resulting in particular from a liquid or an effluent from the nuclear industry. The product, first of all prepared and then packed in the form of a column, makes possible the complete and irreversible fixing of caesium-137.

In this material, the hexacyanoferrate anion is adsorbed on the anion-exchange polymer, which covers a solid support in the form of a film, by interactions of electrostatic type and, for this reason, adheres strongly to the support. This bonding involves phenomena of adsorption in the pores, as in impregnated hexacyanoferrates. The deposition of the hexacyanoferrate is carried out uniformly over the whole of the modified surface of the support. All the possible exchange sites of the polymer are exchanged and the composition and the properties of the material are perfectly controlled and reproducible, in contrast to the materials of the prior art. There no longer exist, at the surface of the material, residual hexacyanoferrates capable of being released and subsequently disrupting the fixing process.

The material exhibits a contact surface area of the same order of magnitude as the specific surface of the support selected; the reactivity of the copper hexacyanoferrate is thus increased.

The coefficient of distribution of caesium is high (Kd >100 000) and comparable with those of impregnated hexacyanoferrates with amounts of hexacyanoferrate of 1 to 2% by weight with respect to the weight of support. This is the reason in particular why it is possible to readily store the material of this document, which is stable and essentially inorganic. The process for fixing at least one metal cation (for example Cs⁺) can be implemented separately, either in “column” mode or in “batch” mode, with stirring.

However, in this document, following the example of numerous documents of the prior art, the process for synthesizing, then fixing and decontaminating involves a batchwise process requiring several stages, with transfer of solvents and of reactants. Thus it is only once the metal hexacyanoferrate precipitate has been synthesized that it is placed in a column for the decontamination of the effluents.

In addition, in the abovementioned patent publication, in order to obtain good adherence, good hold of the polymer to the support and a stable film on this same support, it is in the majority of cases necessary to crosslink the polymer via covalent bonding to said support. Crosslinking is essential in particular in order to obtain a stable film which adheres to the support, such as silica, with polymers such as polyethyleneimines (PEI) and polyvinylimidazoles (PVI). In point of fact, these stages of crosslinking and/or of fixing via covalent bonding or grafting in order to obtain the immobilization of the polymer, for example of PEI, on the support are lengthy and difficult. This is because these stages are carried out batchwise in an organic medium with reaction times ranging up to 48 hours and require drying of the support beforehand under vacuum.

Furthermore, some documents, such as the document by M. T. Ganzeli Valentini, R. Stella and L. Maggi, J. of Radioanalytical and Nuclear Chemistry, 114, No. 1, 1987, 105-112, report processes in which the synthesis is carried out in a column on inorganic supports, such as silica, these processes being based on the principle of percolation of reactants at low flow rates requiring that the solid support be packed down.

In these processes, the reactants, such as copper sulphate and sodium ferrocyanide, are mixed beforehand to form a mixed hexacyanoferrate formed of copper, of sodium and of potassium. This hexacyanoferrate is subsequently introduced at a very low flow rate into a column comprising the inorganic support. Once the hexacyanoferrate has been fixed to the silica, a number of purification stages are carried out batchwise, thus making it necessary to resort to again placing in a column for the decontamination.

When metal ions, such as cupric ions, are complexed by the polymer, problems of subsequent release of these ions, from the composite solid material, have been observed, requiring lengthy washing stages after contact of the support with the metal salt, such as copper nitrate.

Another document, from A. A. Kopyrin, A. K. Pyartman et al., Radiochemistry, 42, No. 1, 2000, 83-85, describes that only the fixing of the hexacyanoferrate is carried out in a column, whereas, subsequently, the precipitation and the purification are carried out batchwise, with slow reaction times, since they are of the order of seven days.

The major disadvantage of these processes is that one and only one synthesis stage is carried out at the same time in the same column, namely the fixing of the ferrocyanide, which is generally the simplest stage of the synthesis, whereas several stages of this same synthesis are carried out under batchwise conditions, in particular the most tedious stages, such as the purifications. The product obtained subsequently requires a further stage of drying at high temperature to remove the excess cyanides. The decontamination again requires placing the product in a column. Another disadvantage may be mentioned: preferential pathways may exist in the column, which, and this fact should be stressed, is in all the processes of the prior art a packed-down stationary bed column, which pathways would be capable of bringing about nonhomogeneous deposition of metal hexacyanoferrate.

It emerges from the above that there exists a need for a process for the preparation of a composite solid material which fixes inorganic contaminants based on metal hexacyanoferrate, comprising a solid support coated with a thin film of an anion-exchange polymer to which is fixed an insoluble metal hexacyanoferrate forming a thin layer, which can be carried out entirely continuously.

There exists in particular a need for a process for the preparation of a composite solid material which fixes contaminants which can be carried out continuously in one and the same chamber, which is simple and reliable and which comprises a limited number of stages, all carried out continuously.

In addition, this process must make it possible to prepare a material with properties which are stable, perfectly controlled and without random variations and in which the polymer is fixed in an adherent and stable way to the support, even without having recourse to complicated and lengthy grafting and/or crosslinking operations carried out under batchwise conditions.

It is very obvious that the material prepared by the process must also meet the criteria and requirements which are for the most part already met by the solid composite material of the prior art represented by FR-A-2 765 812.

In particular, this material must be chemically and mechanically stable in order to be able to be thus packed in a column allowing continuous operation of the process for fixing contaminants, i.e. for decontamination.

The composite solid material which fixes inorganic contaminants must also have excellent fixing, in particular decontamination, properties, that is to say properties analogous to, indeed even better than, in particular, those of hexacyanoferrates not impregnated on a support.

The solid material which fixes inorganic contaminants must also combine good mechanical stability with a high reaction rate, in contrast to products in compact form, the low specific surface of which results in slow reaction rates.

In other words, the solid material which fixes inorganic contaminants based on metal hexacyanoferrates must exhibit, inter alia, excellent mechanical and chemical stabilities, a high coefficient of affinity or of decontamination, a high reactivity and good selectivity.

These properties must be obtained with a minimum amount of inorganic fixing agent of metal hexacyanoferrate type.

Furthermore, in particular in the case of the fixing of radioactive elements, it is necessary for the composite solid material which fixes inorganic contaminants to be able to be easily stored and/or vitrified, without risk, by known processes.

Finally, the material prepared by this process must exhibit a composition and properties which are perfectly reproducible and controlled.

One aim of the present invention is thus to provide a process for the preparation of a composite solid material which fixes inorganic contaminants based on metal hexacyanoferrates which does not exhibit the disadvantages, faults, drawbacks and limitations of the processes for the preparation of composite solid materials which fix inorganic contaminants of the prior art, as represented essentially by the document FR-A-2 765 812, which overcomes the problems of the processes of the prior art and which meets, inter alia, all the requirements mentioned above.

Another aim of the present invention is to provide a process for fixing at least one inorganic contaminant present in a solution which employs said composite solid material and which can be carried out continuously, with in particular a reduced time and high efficiency.

This aim, and yet others, are achieved, in accordance with the invention, by a process for the preparation of a composite solid material which fixes inorganic contaminants, based on metal hexacyanoferrate, comprising a solid support coated with a film of an anion-exchange polymer to which is fixed an insoluble metal hexacyanoferrate forming a thin layer, said process essentially comprising at least one step in which said solid support is brought into contact with at least one liquid reactant and optionally at least one step in which washing is carried out with a washing liquid, characterized in that all of the steps of the process are carried out continuously in one and the same receptacle, such as a column, in which the support forms a fluidized bed, the fluidization of which is provided by said at least one reactant or washing liquid.

The process according to the invention is in its entirety carried out continuously in one and the same receptacle, such as a column, which means that there is no transfer of the material from one receptacle to another during the process and that all the steps of the preparation are successively carried out continuously, without a break, without interruption, in contrast to the processes of the prior art, where some steps are carried out under batchwise conditions and others are carried out continuously, with each time a change in receptacle and a transfer of the material.

This results in an important saving in time, while the yields and the production capacities obtained are considerably higher.

The process according to the invention makes it possible to prepare large amounts of material, for example which can range up to hundreds of kilograms, in a relatively short reaction time.

In addition, this process is simple, as it requires only a single receptacle, and reliable, the fluidization technique being a known and tested technique.

The term “all the steps of the process” is understood to mean that all the steps of the process are carried out in the same receptacle, for example a column (but this receptacle might also take other forms).

The term “preparation” generally covers any operation targeted at obtaining the target material, namely synthesis, purification or other operation. However, such a process essentially comprises at least one step in which the solid support is brought into contact with at least one liquid reactant and at least one step in which washing is carried out with the washing liquid.

In accordance with the invention, during the process, the solid support forms a fluidized bed, the fluidization of which is provided by said at least one liquid reactant or washing liquid.

Fluidization is generally provided by a very high flow rate (80 to 280 ml/min) of this reactant or washing liquid conveyed into the bed, stationary beforehand, of solid support, countercurrentwise from the bottom upwards into the bed of solid support.

The synthesis of the material, and in particular the deposition of the insoluble metal hexacyanoferrate on the support, is greatly facilitated by the use of the fluidized bed, which provides both the chemical reaction and constant movement of the support.

The process according to the invention makes it possible in particular to obtain a homogeneous and uniform deposit of metal hexacyanoferrate over the solid support coated with cationic polymer obtained in the same receptacle during the preceding stage of the same continuous process.

The uniformity of the deposit over the support, by virtue of the use of the fluidized bed, no longer requires that the bed be packed down and prevents the problems due to the preferential pathways encountered in the prior art.

The material prepared by the process according to the invention, essentially because of the use of a fluidized bed during its preparation, thus exhibits improved intrinsic properties with respect to the prior art, in which the preparation of the material is not in its entirety carried out continuously in one and the same column and in a fluidized bed.

As has already been indicated above, the material prepared by the process according to the invention is coated with a homogeneous and uniform layer of the hexacyanoferrate, which is not the case in the analogous materials of the prior art prepared under batchwise conditions and, moreover, without employing a fluidized bed.

It has also been found that the material prepared by the process of the invention exhibits distribution constants, for example with respect to a solution laden with radioactive caesium, which are much higher than those obtained with the products prepared under batchwise conditions, for example 10⁴ ml/g instead of 10³ ml/g.

In addition to these improved properties and these advantages related fundamentally to its specific method of preparation, the material according to the invention has a structure substantially analogous to that disclosed in the document FR-A-2 765 812, namely the material prepared by the process according to the invention exhibits a specific structure in which the inorganic fixing agent as such, that is to say the metal hexacyanoferrate, exists in the form of a thin layer which is immobilized on a polymer phase fixed to a support, said support being solid and advantageously chemically and mechanically stable and being protected and isolated from the action of the medium by the underlying polymer layer.

For this reason, the material prepared according to the invention is also chemically and mechanically stable and combines these stabilities with a high reaction rate, and is perfectly suitable for packing in a column for the fixing, i.e. the decontamination. In fact, it will be seen later that this column is, preferably, advantageously according to the invention the same as that in which the material is prepared.

By way of example, the material prepared according to the invention proved to possess perfect mechanical stability on a column, after washing with pure water for several days, corresponding to more than 10 000 column volumes.

In the material prepared according to the invention, the hexacyanoferrate anion is adsorbed on the polymer by interactions of electrostatic type and, for this reason, adheres strongly to the support.

The bond which exists between the anionic part of the metal hexacyanoferrate and the support coated with the anion-exchange polymer is a bond of electrostatic type, which is not a weak bond of mechanical nature essentially involving phenomena of adsorption in the pores, as is the case in impregnated hexacyanoferrates, for example impregnated on a silica gel.

The deposition of the hexacyanoferrate is, as has already been indicated, carried out uniformly over the entire modified surface of the support.

All the possible exchange sites of the anion exchange polymer are exchanged; the composition and the properties of the material according to the invention are therefore perfectly controlled and reproducible. Excess residual hexacyanoferrate, capable of being released and subsequently disrupting the fixing process, is no longer present at the surface of the material.

The material prepared according to the invention furthermore exhibits a contact surface area which is of the same order of magnitude as the specific surface of the chosen support. Consequently, the reactivity of the hexacyanoferrate is increased.

The distribution coefficient of the material prepared according to the invention, which is preferably from 10 000 to 100 000 (mg/l) for one gram of material, is high and is comparable with that of bulk hexacyanoferrates but the amount of hexacyanoferrates employed are advantageously much lower than those of hexacyanoferrates impregnated on silica.

Thus, the material prepared according to the invention generally comprises an amount of fixed metal hexacyanoferrate of 1 to 10% by weight, preferably of 2 to 3% by weight, with respect to the weight of the support; this value should be compared with the value of 30% for the hexacyanoferrates impregnated on silica mentioned above.

The amount of ferrocyanide which is fixed and discharged after it has been used is limited and the same effectiveness is obtained for an amount of hexacyanoferrate which is, for example, ten times lower, as all the product fixed is effective.

This is the reason in particular why it is possible to readily store the material prepared according to the invention, which is stable and essentially inorganic, and/or to vitrify it, which was until now impossible with the materials of the prior art.

More specifically, the solid support can be chosen from the supports known to a person skilled in the art and suitable for the use described; these solid supports can be organic or inorganic and are generally chosen from chemically and mechanically stable solid supports.

The support will thus preferably be chosen from inorganic oxides, such as silica, alumina, titanium oxide, zirconium oxide, diatomaceous earth, glasses and zeolites; a preferred support is silica, readily available at a reasonable cost.

The support can be provided in any form but, because it has to be fluidized, it will preferably be provided in the form of particles, such as grains, beads or spheres, or of fibres.

The particle size of the support, in the form of particles, defined by the size of the particles, that is to say the diameter in the case of spherical particles, can vary within wide limits and will generally be from 1 to 500 μm, preferably greater than or equal to 10 μm, preferably greater than or equal to 30 μm, for example.

The specific surface of the support can also be variable, for example from 10 to 500 m²/g, preferably from 30 to 500 m²/g.

The support is preferably a porous support, in order to make possible better fixing of the polymer.

The mean size of the pores of the support is variable and is preferably from 100 to 1 000 Å.

The anion-exchange polymer of the composite solid material which fixes inorganic contaminants according to the invention results from an organic polymer which was optionally provided with cationic groups by any process known to a person skilled in the art.

This organic polymer is preferably chosen from polyvinylimidazoles, copolymers of vinylimidazole with at least one other monomer, for example a vinyl monomer, polyethyleneimines, polyamines and any polymer carrying a cationic group or analogous group or capable of being provided therewith.

Examples of these polymers are given, for example, in the document EP-A-0 225 829 and the document DE-A-30 07 869.

Any polymer is suitable, provided that it forms a highly adherent film or thin film at the surface of the support, for example by adsorption in the pores or by covalent bonding using suitable grafting, and that it is or that it can be a carrier of cationic groups.

Furthermore, and for better hold of the polymer adsorbed on the support, it is generally preferable to crosslink the polymer.

For the grafted polymer, crosslinking is not generally necessary.

According to a particularly preferred embodiment of the invention, the polymer is a noncrosslinked polymer which comprises, as anion-exchange groups, solely quaternary ammonium groups and which does not comprise primary, secondary and tertiary amine groups.

More preferably, said cationic anion-exchange polymer is a polybrene®or hexadimethrine bromide or alternatively poly(N,N,N′,N′-tetramethyl-trimethylenehexamethylenediammonium dibromide) (Cl₁₃H₃₀Br₂N₂)ₓ, CAS No. [2 8728-55-4], which is a water-soluble polymer widely used in biochemical applications and which comprises solely quaternary ammonium groups.

The formula of polybrene® is as follows:

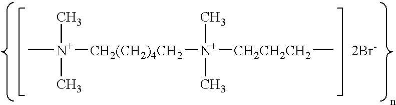

These preferred specific polymers greatly improve the properties of the composite materials of the prior art, in particular of the materials disclosed in the document FR-A-2 765 812. These preferred specific polymers exhibit excellent adherence to the support, such as silica, without requiring any crosslinking.

The preferred polymers adhere to the support in an excellent manner, without crosslinking or fixing via a covalent bond. Because the preferred polymer does not comprise primary and secondary and tertiary groups, the formation of unstable metal complexes is avoided, as is the subsequent release of metal ions, such as copper, from the material.

For this reason, with the preferred polymers, the properties of the composite material are perfectly controlled and stable and are not subject to random variations.

The film is highly adherent to the support and this film is extremely stable. It might be thought that the excellent adherence of the preferred polymers, such as polybrene® to the support originates from the interaction between the NR₄⁺ groups of the polymer and the silanol groups of the support.

The metal hexacyanoferrate which is fixed to the anion-exchange polymer can be any hexacyanoferrate known to a person skilled in the art; it can be chosen, for example, from copper, cobalt, zinc, cadmium, nickel and iron hexacyanoferrates and the mixed hexacyanoferrates relating to these salts.

It should be noted that the process for the preparation of the invention of a composite solid material which fixes inorganic contaminants based on metal hexacyanoferrate, comprising a solid support coated with a film of an anion-exchange polymer to which is fixed an insoluble metal hexacyanoferrate forming a thin layer, is certainly not limited to specific stages, specific operating parameters for these stages, specific reactants and specific optional washing liquids.

On the contrary, the process according to the invention can be carried out with success, whatever the steps involved by this process and the conditions of these steps and whatever the reactants and the washing liquids employed, provided, of course, that all the steps of the process are carried out, in accordance with the invention, continuously in one and the same receptacle in which the support forms a fluidized bed, the fluidization of which is provided by said at least one liquid reactant or optional washing liquid.

In particular, the process according to the invention can, for example, be any process for the preparation of a composite solid material defined above in which, while retaining substantially the same stages, the same reactants and the same washing liquids, the adaptation is carried out which consists in performing all said steps continuously in one and the same receptacle, such as a column, in which the support forms a fluidized bed, the fluidization of which is provided by the liquid reactants or optional washing liquids.

One preparation process which can be adapted in order to be carried out in accordance with the process of the invention, continuously and in a fluidized bed, is, for example, the process disclosed in the document FR-A-2 765 812, reference to the description of which may be made.

Such a process can comprise a crosslinking stage which is difficult and lengthy to carry out, with heating to approximately 60° C. This is the reason why, in a preferred embodiment of the invention, the preparation process is carried out without crosslinking by employing, preferably, specific cationic polymers.

Such a process comprises the following successive stages:

impregnation of a solid support with an aqueous solution of an anion-exchange polymer, in order to form a film of said polymer on said solid support;

washing with demineralized water;

impregnation of the solid support thus coated with a film of anion-exchange polymer with an aqueous solution of alkali metal hexacyanoferrate;

washing with demineralized water said solid support coated with a film of anion-exchange polymer to which is fixed an alkali metal hexacyanoferrate;

addition of an aqueous solution of a metal salt to said coated solid support in order to form a composite solid material which fixes inorganic contaminants comprising the solid support coated with a film of anion-exchange polymer to which is fixed an insoluble metal hexacyanoferrate forming a thin layer;

washing with demineralized water.

In this embodiment of the process of the invention, the anion-exchange polymer is preferably chosen from noncrosslinked anion-exchange polymers comprising, as anion-exchange groups, solely quaternary ammonium groups and not comprising primary, secondary and tertiary amine groups. Polyethyleneimines (PEI) can also be chosen but this involves tedious intermediate and final rinsing stages.

In addition to the advantages already mentioned above, related to the continuous use in a fluidized bed of the process, the process according to the invention in this preferred embodiment exhibits numerous advantages, essentially by virtue of the use of the specific polymers described above and preferably of a polybrene, inter alia:

the adsorption of the polymer, which is soluble in water, takes place in an aqueous medium, from an aqueous solution, and not in an organic medium, without preliminary drying of the support under vacuum, and this contact time is reduced, for example to 1 hour;

the adherence of the polymer to the support, such as silica, is stable, which eliminates the stages of crosslinking, carried out at 60° C. (very lengthy), and of fixing via covalent bonding; in addition, the step of creating cationic groups does not exist either, since the polymer advantageously comprises the necessary cationic groups from the start.

However, for PEI, it is necessary to resort to a step at acidic pH in order to protonate it.

In other words, in this embodiment of the process of the invention, a highly adherent film of polymer is obtained in a single step of adsorption by simple contact, without placing under vacuum, for a time, for example, in the region of 1 hour, without preliminary drying and crosslinking, instead of resorting to at least three lengthy and difficult steps, the duration of which can range up to 48 hours, which are energy demanding and which require placing under vacuum, drying and heating.

In addition:

the fixing of the hexacyanoferrate anion by impregnation using an alkali metal hexacyanoferrate solution can be carried out in a simplified way, preferably from pure water;

during the step of precipitating the insoluble metal hexacyanoferrate, the formation of copper chelates is avoided as the polymer employed in this preferred form of the process according to the invention, which is advantageously a polybrene®, generally does not comprise primary, secondary or tertiary amine groups in order to exclude the formation of complexes with copper.

In other words, during this step of precipitation of the metal hexacyanoferrate, such as copper hexacyanoferrate, there is no formation of complexes between the polymer, such as polybrene®, and the metal ions of the solution, such as the copper ion, since the nitrogen atoms are in the form of quaternary ammoniums devoid of free doublets, which is not the case with the supports, such as silica, treated with other polymers, such as PEI and PVI, or with aminated silicas, for which the formation of unstable complexes between the nitrogen atoms and the metal, such as copper, has been observed.

Consequently, in this preferred form of the process according to the invention, and because there is no release of metal ions from the material, the lengthy washing operations subsequent to bringing the support into contact with a metal salt are greatly reduced.

Finally, the invention relates to a process for fixing at least one inorganic contaminant, such as a metal cation present in a solution, in which, first of all, a composite solid material which fixes inorganic contaminants based on metal hexacyanoferrate, comprising a solid support coated with a film of an anion-exchange polymer to which is attached an insoluble metal hexacyanoferrate, is prepared by the process described above, without a final drying step, and then said solution is brought continuously into contact with said composite solid material which fixes inorganic contaminants, in the same receptacle, such as a column, in which said material was prepared.

This fixing process exhibits the advantage of being able to be carried out continuously following, preferably, directly, immediately after, the process for the preparation of the composite solid material; the latter remains in the same receptacle, which eliminates a lengthy and difficult transfer operation, and the packing of the material in a column, which is also lengthy and difficult.

In addition, the composition of the product obtained is such that there is no need, on conclusion of the preparation, to resort to a final step of drying the material before the decontamination, i.e. the fixing of the contaminants, as there are no excess ferrocyanides.

This is because, in the final product synthesized, the composition of the product is such that M/Fe (M=metal), for example Cu/Fe, is 1, whereas, for a product synthesized under batchwise conditions, Cu/Fe is 2.

The decontamination, i.e. the fixing, can therefore be carried out, according to the invention, immediately after the preparation, without drying, in the same equipment. The material and the solution to be contaminated can be brought into contact in the column, for example by percolation of the solution through the material or else, in a particularly advantageous way, via a (in a) fluidized bed similar to that used for the synthesis of the material, said fluidized bed being formed by the composite solid material, the fluidization of which is provided by the solution comprising the inorganic contaminant; that is to say that, in this case, it is the whole of the fixing process, including the synthesis, which is carried out in the same fluidized bed and in the same receptacle, such as a column.

It may be said that it is by virtue of the specific characteristics inherent in the preparation process, affecting the material prepared, that the fixing process can be carried out, preferably, immediately after the latter in the same receptacle, preferably also in a fluidized bed, without loss of time, without transfer and without another packing step.

The fixing process according to the invention is very simple as it employs only one device, namely a single receptacle, such as a column, which is extremely advantageous, in particular in the case of the treatment of radioactive fluids. Furthermore, the overall duration of the process is greatly reduced.

In addition, the process for fixing contaminants according to the invention exhibits all the other advantages inherent in the material prepared, these advantages being essentially related to the preparation in a fluidized bed, which have already been indicated above, namely in particular markedly greater partition constants and the absence of preferential pathways.

The invention will now be described in more detail in what follows, reference being made in particular to the preparation process in its preferred embodiment.

The first step of this process consists of the impregnation of a solid support with a solution of organic polymer on said solid support.

The solid support is one of those which have already been mentioned above, a preferred support being Lichrospher® 100 silica from Merck®. The polymer is also one of the preferred polymers which were mentioned above, the polymers which are further preferred being a polybrene® (PB), preferably a polybrene® with a molecular mass of 4 000 to 6 000 g/mol supplied by Sigma Aldrich®, or else a polyethyleneimine with a molecular mass of 10 000 g/mol supplied by the same company.

In accordance with the invention, this solid support is placed in a receptacle, such as a column, and forms a stationary bed at the beginning of the process. The fluidization of this bed is created by circulating, in this stationary bed, a (countercurrentwise) stream of liquid reactant or optionally a washing liquid. The techniques for creating a fluidized bed are well known to a person skilled in the art. Generally, the reactant or liquid enters the receptacle or the column via an inlet orifice and passes through the stationary bed at a flow rate sufficient to bring about its fluidization, without, however, entraining the particles of which the bed is formed, and emerges via an outlet orifice. The receptacle, such as a column, is generally vertical and is, provided, for example, in the form of a vertical straight cylinder into which the liquid or liquid reactant enters via an inlet orifice provided at the base of the cylinder and passes in vertical upward flow through the bed, which is thus fluidized, and the liquid is discharged at the top of the column via an outlet orifice provided in the other base of the cylinder.

The polymer solution is, according to an advantageous aspect of the invention, a solution in water, for example in demineralized water.

The solution generally has a concentration of 20 to 100 g/l.

Impregnation is carried out by bringing the solid support into contact with the polymer solution at a flow rate, for example of 80 to 280 ml/min, sufficient to bring about fluidization, for a sufficient duration, which is, according to the invention, astonishingly short, for example 1 h (instead of 24 to 48 hours under batchwise conditions), in return for which a uniform coating of polymer on the solid is obtained, which coating isolates and protects the solid support, which matches the shapes and porosities thereof and which retains the specific surface thereof.

The fixing of the polymer to the solid support is essentially governed by an adsorption phenomenon with interactions of electrostatic type; this fixing is, according to the invention, relatively strong without requiring grafting via covalent bonds.

On conclusion of this step, a solid support coated with a thin film of anion-exchange polymer is thus directly obtained.

The term “film” is understood to mean, as already indicated above, a uniform coating over the entire surface of the solid support which retains substantially the specific surface of the latter.

This film generally has a thickness of 2 to 3 nm.

Rinsing, with demineralized water, of the solid support coated with a film of polymer is subsequently carried out continuously, preferably immediately after the first step. For this, it is sufficient simply to replace the stream of polymer solution with a stream of demineralized water at a flow rate, for example of 80 to 280 ml/min, sufficient to maintain the fluidization.

In the following step, the support coated with a thin film of anion-exchange polymer is subsequently impregnated with an aqueous solution of alkali metal hexacyanoferrate(II) or -(III).

This step is again carried out continuously, preferably immediately after the preceding step. For this, it is sufficient simply to replace the stream of demineralized water with a solution of alkali metal hexacyanoferrate.

The starting alkali metal. hexacyanoferrate is preferably chosen from sodium hexacyanoferrate(II), sodium hexacyanoferrate(III), potassium hexacyano-ferrate(II) or potassium hexacyanoferrate(III).

The aqueous solution of alkali metal hexacyanoferrate employed has a variable concentration, that is to say that the concentration of the alkali metal hexacyanoferrate(II) or -(III) salt, in particular the potassium or sodium salt, is preferably from 1 to 100 g/l, for example 50 g/l.

Furthermore, the aqueous hexacyanoferrate solution employed is prepared so that the ratio by weight of the alkali metal hexacyanoferrate(II) or -(III) salt, in particular the potassium or sodium salt, to the amount of the impregnation support, essentially composed of the initial solid support, such as silica, is preferably from 5 to 10%.

Impregnation does not have to be carried out at a definite, stable and controlled pH, for example controlled by a buffer. It is a solution in water, preferably pure, demineralized water.

The flow rate of the solution is, for example, from 80 to 280 ml/min, so as to provide or to maintain. the fluidization.

The fixing of the anionic part [Fe(CN)₆]⁴⁻ to the cationic groups of the polymer is thus obtained. This fixing takes place by formation of bonds of electrostatic type which are relatively strong according to the medium and this fixing is generally quantitative, that is to say that all the cationic sites of the polymer react. The fixing therefore does not exhibit any random nature.

The solid support thus coated with a thin film of anion-exchange polymer to which is fixed an alkali metal hexacyanoferrate is subsequently subjected to a washing operation. The washing is carried out continuously, preferably immediately after the preceding step.

The aim of the washing operation is to remove the alkali metal hexacyanoferrate salts which have not been fixed to the polymer and the washing operation makes it possible to obtain a composite material which fixes inorganic contaminants in which free unbonded hexacyanoferrate, which may be released, is no longer present.

The washing is carried out with demineralized water.

The amount of rinsing solution used can vary and can range from 100 to 1 000 ml per gram of product treated.

The flow rate of the rinsing solution is such that the fluidization is appropriately provided.

The following step is the addition of an aqueous solution of metal salt to the solid support coated with a film of an anion-exchange polymer to which is fixed the hexacyanoferrate anion.

This step is also, according to the invention, carried out continuously, preferably immediately after the preceding step, by replacing the rinsing solution with a solution of metal salt.

The metal salt present in this aqueous solution is a salt, the metal of which corresponds to the insoluble hexacyanoferrate which it is desired to obtain, as it has already been indicated above.

This metal is chosen, for example, from copper, cobalt, zinc, cadmium, nickel, iron, and the like.

The metal salt will therefore be, for example, a nitrate, a sulphate, a chloride or an acetate of one of these metals at a concentration in the aqueous solution preferably of 0.01 to 1 mol/l, more preferably of 0.02 to 0.05 mol/l.

Furthermore, the amount of salt used is preferably approximately 0.4 mmol/g of support treated.

The addition of the aqueous solution of the metal salt does not have to take place at a definite pH using a buffer solution. The aqueous solution is a solution in pure demineralized water.

The flow rate of the aqueous solution of the metal salt is such that the bed remains fluidized.

Finally, in a last step, the final material obtained, which thus comprises the solid support coated with a thin film of an anion-exchange polymer to which is fixed an insoluble metal hexacyanoferrate forming a thin layer, is washed.

This final washing step is carried out in the same way and under the same conditions as the washing stage already described above, using pure demineralized water.

This step is carried out continuously and preferably immediately after the preceding step.

It is generally necessary to introduce, into the demineralized water, an alkali metal salt, for example a sodium salt, the anion of which is preferably the same as that of the metal salt employed during the preceding stage, and optionally, in addition, the corresponding acid: use may be made, for example, of sodium nitrate and nitric acid.

This washing operation makes it possible to remove the excess metal salt and to obtain a stable final product with the perfectly defined composition. It has to be followed by a final rinsing step with demineralized water.

Finally, a drying step is carried out.

Generally, the drying is continued until the weight of the support remains substantially constant.

However, this drying step is preferably generally omitted if, subsequent to it and continuously, the fixing of contaminants present in a solution is carried out.

The content by weight of inorganic fixing agent, that is to say of insoluble metal hexacyanoferrate, fixed to the anion-exchange polymer is generally from 1 to 10%, for example 3%, with respect to the weight of the inorganic support, such as silica. It has been found, by analysis by neutron activation, that the M₂/Fe atomic ratio can vary from 1 to 5 without the fixing properties, in particular decontamination properties, being affected.

The composite solid material which fixes inorganic contaminants prepared by the process according to the invention is preferably immediately after its preparation, the optional final drying step being omitted, employed in the fixing of at least one inorganic contaminant, for example of a metal cation present in a solution, in which said solution is brought into contact with said composite solid material which fixes inorganic contaminants.

According to the invention, this fixing is carried out continuously in the same receptacle, such as a column, in which the solid material was prepared. For this reason, no packing or transfer is necessary.

The materials prepared according to the invention, because of their excellent properties, such as an excellent exchange capacity, an excellent selectivity and a high reaction rate, are particularly suitable for such a use.

This excellent effectiveness is obtained with reduced amounts of inorganic fixing agent, such as of insoluble hexacyanoferrate.

The packing in a column makes it possible to continuously treat large amounts of solutions with a high flow rate of the latter, for example from 1.5 to 80 ml/min.

Because of its continuous use, the fixing process can thus be readily incorporated in an existing plant, for example in a treatment line comprising several steps.

The solutions which can be treated by the process of the invention and with the composite solid material which fixes inorganic contaminants prepared according to the invention are highly varied and can even comprise, for example, corrosive, acidic, basic or other agents, because of the excellent chemical stability of the material prepared according to the invention.

The material prepared according to the invention can be used in particular over a very wide pH range.

For example, aqueous nitric acid solutions with a concentration ranging, for example, from 0.1 to 3M, acidic or neutral solutions up to a pH of 8, basic solutions, and the like, can be treated. However, there are grounds for possibly adapting the nature of the solid support to the nature of the solution treated. For example, it is known that silica generally does not withstand a basic pH and that it is then preferable to use a solid support, for example, made of TiO₂. The use of the composite material can then be extended, for example, up to a pH of 10.

The inorganic contaminant capable of being fixed in the fixing process according to the invention can be any inorganic contaminant, that is to say, for example, any contaminant resulting from (based on) a metal or an isotope, preferably a radioactive isotope, of this metal, capable of existing in solution.

This contaminant is preferably chosen from anionic complexes, colloids, cations and their mixtures.

It is preferably a contaminant, such as a cation, resulting from an element chosen from Tl, Fe, Cs, Co, Ru, Ag, and the like, and the isotopes, in particular the radioactive isotopes, of the latter, among which may be mentioned ⁵⁸Co, ⁶⁰Co, ⁵⁵⁻⁵⁹Fe, ¹³⁴Cs, ¹³⁷Cs or ^{103,105,105,107}Ru. The metal cation is in particular caesium Cs+or thallium T1²⁺.

The anionic complex is, for example, RuO₄²⁻.

A preferred use of the material prepared according to the invention is the fixing of caesium, which contributes to a large part of the gamma activity of the liquids from the nuclear industry and which is selectively fixed by hexacyanoferrates.

The concentration of the contaminant(s), such as cation(s), can vary within wide limits: for example, it can be, for each of the latter, from 0.1 picogram to 100 mg/l, preferably from 0.01 mg/l to 10 μg/l.

The solution to be treated by the fixing process of the invention is preferably an aqueous solution which can, in addition to the contaminant(s), such as one or more cation(s), to be fixed, comprise other salts in solution, such as NaNO₃ or LiNO₃ or Al(NO₃)₃ or any other soluble alkali metal or alkaline earth metal salt, at a concentration which can reach up to 2 mol/l. The solution can also comprise, as indicated above, acids, bases and even organic compounds.

The solution to be treated can also be a solution in a pure organic solvent, such as ethanol (absolute alcohol), acetone or other organic solvent, in a mixture of these organic solvents, or in a mixture of water and of one or more of these water-miscible organic solvents.

The material prepared according to the invention thus exhibits the advantage of being able to treat solutions which cannot be treated with organic resins.

This solution can consist of a process liquid or of an industrial or other effluent which can result in particular from the nuclear industry and nuclear plants or from any other activity related to nuclear technology.

Mention may be made, among the various liquids and effluents from the nuclear industry, nuclear plants and activities employing radionuclides which can be treated by the fixing process of the invention, for example, of cooling waters from power stations and all the various effluents coming into contact with radio-isotopes, such as all aqueous washing solutions, solutions from the regeneration of resins, and the like.

However, it is obvious that the fixing process according to the invention can also be employed in other nonnuclear, industrial or other, fields of activities.

Thus, the hexacyanoferrates selectively fix thallium and this property might be taken advantage of in the purification of effluents from cement plants for reducing or eliminating the discharges and emissions of this element, which is a virulent poison.

The contact time of the solution to be treated with the exchange material can vary and can range from 1 minute to 1 hour with continuous operation according to the invention.

It should be noted that this duration is significantly shorter than in the analogous processes carried out under batchwise conditions or partly under batchwise conditions and partly continuously, in different receptacles.

On conclusion of the fixing process, the fixing (exchanging) composite solid material prepared according to the invention, in which, for example, the metal cations of the hexacyanoferrate have been exchanged by the cations present in the solution, can be stored directly, as its very high mechanical and chemical stabilities and its essentially inorganic nature allows such storage without decomposition of the product occurring, which decomposition results in emanations of hydrogen, or else it can be treated by a process which makes possible conditioning for long-term storage, for example by vitrification.

Vitrification is particularly appropriate in the case where the cations fixed are radioisotopes and where the support is silica.

The material prepared according to the invention, by virtue of its specific structure and in contrast to the exchange materials of the prior art based on hexacyanoferrate, can be vitrified without danger as the amounts of inorganic fixing agent are limited and decontamination in the air is without danger.

The following examples, given by way of illustration and without limitation, first of all illustrate the preparation process of the invention, in which there is carried out the preparation of composite exchange materials in accordance with the invention in a fluidized bed column, and then the results obtained by employing these composite exchange materials in the context of the fixing of cations in accordance with the fixing process of the invention, that is to say in the same column as that which was used for the synthesis of the materials according to the first stage of the fixing process of the invention, the process being applied to the fixing of caesium from radioactive effluents.

The examples illustrate the synthesis process and then the fixing process.

### EXAMPLE 1

In this example, the synthesis was carried out of hexacyanoferrates in a thin layer, the hexacyanoferrates being immobilized on silicas covered with an anion-exchange polymer phase, said phase being prepared from a polybrene® or from polyethyleneimine (PEI), in accordance with the preparation, i.e. synthesis, process of the invention: namely in a fluidized bed column (Examples 1A and 1B).

Furthermore, by way of comparison, the synthesis was also carried out of hexacyanoferrates in a thin layer by a preparation process not in accordance with the invention: namely under batchwise conditions: Example 1C, or under mixed conditions: Example 1D.

### EXAMPLE 1A

In this example, in accordance with the process according to the invention, the anion-exchange polymer is a polybrene (PB) having the following structure and the following characteristics: molar mass 4 000 to 6 000 g/mol.

The procedure is as follows:

a silica support (Silica Gel 100®) supplied by Merck®, having a particle size of 0.063 to 0.200 mm and a porosity of 100 μm, is impregnated with polybrene (PB) supplied by Sigma Aldrich® by bringing into contact in a fluidized bed column for a period of time of 1 h or 24 h in a 15% by weight solution of polymer in demineralized water at flow rates ranging from 1.5 ml/min to 280 ml/min, depending on the amount of product synthesized;

the support thus coated is rinsed with demineralized water; it should be noted that no drying under vacuum is to be carried out;

the anion-exchange film-coated support is brought into contact with, i.e. impregnated by, a concentrated solution of sodium hexacyanoferrate(II) (50 g/l) in water (no buffer);

the support is subsequently rinsed with demineralized water;

a copper hexacyanoferrate(II) is formed on the film-coated surface by addition of a 2×10⁻²M aqueous solution of copper(II) nitrate in demineralized water;

the excess hexacyanoferrate(II) is removed by washing with a sodium nitrate solution and subsequently with demineralized water.

The elemental analysis of the final product obtained is given in Table I below.

### EXAMPLE 1B

In this example, in accordance with the process according to the invention, the ion-exchange polymer is a polyethyleneimine (PEI) supplied by Sigma Aldrich.

The procedure is the same as in Example 1A, except that the polymer produced is different and is crosslinked in a fluidized bed.

The elemental analysis of the final product obtained is also given in Table I below.

TABLE I
Elemental composition of the materials prepared
according to the invention based on copper hexacyanoferrate
(the percentages are percentages by weight per g of silica)

| | | Weight of | | | |
|---|---|---|---|---|---|
| | | product | Cu | Fe | |
| | Polymer | synthesized | (% by | (% by | Cu/Fe |
| Samples | absorbed | (g) | weight) | weight) | (at/at) |
| Ex. 1A | PB | 30 | 0.96 | 0.5 | 1.77 |
| Ex. 1B | PEI | 100 | 1.07 | 1.40 | 0.67 |

### EXAMPLE 1C

Comparative

In this example, the material was prepared under batchwise conditions in the following way:

a silica support (Silica Gel 100®) supplied by Merck®, having a particle size of 0.063 to 0.200 mm and a porosity of 100 μm, is impregnated with polyethyleneimine (PEI) supplied by Sigma Aldrich® by bringing into contact under batchwise conditions for a period of time of 10 h in a 15% by weight solution of polymer in demineralized water and crosslinking is subsequently carried out for 2 h at reflux at 600° C. with a crosslinking agent, 1,4-butanediol diglycidyl ether (BUDGE), sold by Aldrich;

the support thus coated is rinsed with demineralized water and dried under vacuum;

the anion-exchange film-coated support is brought into contact under batchwise conditions with, i.e. impregnated by, a concentrated solution of sodium hexacyanoferrate(II) (50 g/l) in water for 4 h;

the support is subsequently rinsed with demineralized water;

a copper hexacyanoferrate(II) is formed on the film-coated surface by addition of a 2×10⁻²M aqueous solution of copper(II) nitrate in demineralized water for 4 h;

the excess hexacyanoferrate(II) is removed by washing with a 2M sodium nitrate solution, subsequently a 0.1M nitric acid solution and subsequently with demineralized water.

### EXAMPLE 1D

Comparative

In this example, the procedure for preparing the material is mixed: it was prepared under batchwise conditions and in a column with packing down of the phase (which is different from the fluidized bed according to the invention) in the following way:

a silica support (Silica Gel 100®) supplied by Merck®, having a particle size of 0.063 to 0.200 mm and a porosity of 100 μm, is impregnated with polyethyleneimine (PEI) supplied by Sigma Aldrich® by bringing into contact under batchwise conditions for a period of time of 10 h in a 15% by weight solution of polymer in demineralized water and crosslinking is subsequently carried out for 2 h at reflux at 60° C. with a crosslinking agent, 1,4-butanediol diglycidyl ether (BUDGE), sold by Aldrich;

the support thus coated is rinsed with demineralized water and dried under vacuum;

the anion-exchange film-coated support is packed down in a column and brought into contact and impregnated by percolation at a low flow rate, ranging from 1.5 to 5 ml/min, with a concentrated solution of sodium hexacyanoferrate(II) (50 g/l) in water;

the support is subsequently rinsed with demineralized water;

a copper hexacyanoferrate(II) is formed on the film-coated surface by addition of a 2×10⁻²M aqueous solution of copper(II) nitrate in demineralized water;

the excess hexacyanoferrate(II) is removed by washing with a 2M sodium nitrate solution, subsequently a 0.1M nitric acid solution and subsequently with demineralized water.

EXAMPLE 2

Caesium Fixing Tests

In this example, the fixing of radioactive caesium ¹³⁴Cs and ¹³⁷Cs present in various effluents was studied with regard to various products based on hexacyanoferrate, namely:

the composite exchange materials according to the invention prepared according to the first stage of the process of the invention in Examples 1A and 1B above;

the comparative materials 1C and 1D.

The selectivity of caesium for the phases, products or composites is defined by virtue of the constant Kd (1) for distribution between a solid phase and a liquid phase laden with ¹³⁴Cs and ¹³⁷Cs.

$$Kd = \frac{amount of Cs * fixed per gram of solid phase}{amount of Cs * remaining per ml of solution} \qquad ( 1 )$$

The greater the value of Kd, the greater the proportion of Cs* retained in the solid phase. A Kd value of greater than 10 000 for contact times of 24 h represents an excellent affinity of caesium for the solid phase.

The radioactive effluents treated are real effluents resulting from the Osiris nuclear reactor at the Centre for Nuclear Studies at Saclay, the characteristics of which relating to radioactivity are mentioned in Table II. They are, first, the cooling water from the reactor, which is denoted by “OSI” in the table and which has a neutral pH, and, secondly, the solution for rinsing, i.e. regenerating, the resins, which is denoted by “BF6” in the table and which is composed of a 0.1M nitric acid solution. In order to increase the accuracy of the counts, a tracer, ¹³⁴Cs, was added to the OSI solution.

TABLE II
Radioactivity of the solutions treated in curies per m³

| | ¹³⁴Cs | ¹³⁷Cs |
|---|---|---|
| OSI | 1.02* | 0.36** |
| BF6 | 0.52 | 2.96 |

*Tracer added
**Highly variable according to the solutions

The procedure of the tests is as follows:

10 to 20 mg of product are added to 50 ml (cm³) of radioactive solution to be treated and are stirred for a period of time of 10 minutes or of a day, depending on the tests.

At the end of the chosen period of time, the solution is filtered and its radioactivity is measured by gamma spectrometry and compared with that of the starting solution.

The values thus obtained make it possible to calculate the ¹³⁷Cs coefficient of distribution representative of the affinity of the product by this element. In the present case, it may be expressed as being the ratio of the radioactivity fixed per gram of product to the residual radioactivity in solution per cm³ of solution. In other words, the coefficient of distribution Kd of caesium is established according to the relationship (2):

$$Kd = \frac{\begin{matrix}Activity of the blank - \\ Activity of the solution * Volume of filtered solution ( ml )\end{matrix}}{Weight of the sample ( g ) * Activity of the solution} \qquad ( 2 )$$

The greater the value of Kd, the greater the proportion of Cs⁺retained in the solid phase. A Kd value of greater than 10 000 for contact times of 24 h for solutions at pH=7 represents an excellent affinity of caesium for the solid phase.

The results of the tests carried out for different contact times (10 minutes and 1 day) with different solutions (cooling water “OSI” at a pH in the region of 7 and aqueous solution from the washing of resins “BF6”, that is to say 0.1M nitric acid solution, pH=1) and with different samples of products based on hexacyanoferrates prepared by the process according to the invention (Ex. 1A and 1B) and not according to the invention (Ex. 1C and 1D) are combined in Table III below:

TABLE III
Distribution constants of coefficients of distribution
Kd (of caesium) with regard to various products based
on hexacyanoferrates (per g of product)

| | | | | | Aqueous solution | |
|---|---|---|---|---|---|---|
| | | | | | from the washing | |
| | | | Cooling water | | of resins | |
| | | | OSI (pH = 7) | | BF6 (pH = 1) | |
| | Method of | Polymer | Contact time | | | |
| Product-sample | synthesis | adsorbed | 10 min | 24 h | 10 min | 24 h |
| Ex. 1C | Batch | PEI | 10³ | 4.1 × 10³ | 3.1 × 10³ | 10⁴ |
| Ex. 1D | Mixed | PEI | 7.0 × 10³ | >10⁵ | 4.6 × 10³ | 2.0 × 10⁴ |
| | Batch/ | | | | | |
| | Packing | | | | | |
| | down | | | | | |
| Ex. 1A | Fluidized | PB | 2.1 × 10⁴ | >10⁵ | 1.3 × 10³ | 6.3 × 10³ |
| | bed | | | | | |
| Ex. 1B | Fluidized | PEI | 4.0 × 10⁴ | >10⁵ | 1.2 × 10³ | 3.8 × 10⁴ |
| | bed | | | | | |

The results indicated above show that the distribution constants obtained with the products synthesized in a fluidized bed according to the first step of the process of the invention are much greater than those obtained with the products synthesized under batchwise conditions or under mixed conditions.

### EXAMPLE 3

Column Decontamination Tests

The percolation of a radioactive solution, which is an “OSI” solution or a “BF6” solution as defined above, over the phases synthesized in accordance or not in accordance with the invention and packed in the synthesis column makes it possible to determine the affinity of caesium for the latter by calculating the coefficient of decontamination.

The decontamination factor is the activity of the solution before passing over the phase with regard to the activity of the solution after passing over the phase (3).

$$Fd = \frac{Activity of the solution ( for example OSI )}{Activity of the recovered fraction} \qquad ( 3 )$$

In practice, in order to withdraw the solution, a pipe comprising a double filter is immersed in 3 of OSI solution, as described in Table III.

The first filter is a sintered glass filter which retains the particles which are larger than 20 μm; the following filter is a filter with a lower porosity. A peristaltic pump placed in series withdraws the solution, at a flow rate of 1.5 to 5 ml/min, to a column made of stainless steel (30*5 mm) comprising 1 g of composite. This column is closed at each end by a sintered glass filter and is shielded over its entire height by a lead castle with a thickness of 5 cm. At the column outlet, 50 ml of eluate are collected in an eluate flask every 250 ml of treated solution. The entire assembly is placed in a retaining tank with a volume of 10 ml. The reactivity of the eluates, and of the control, is subsequently measured by gamma spectrometry.

The results are listed in Table IV.

TABLE IV
Coefficient of decontamination as a function of the
column volume and of the nature of the composite product

| | | | Flow | |
|---|---|---|---|---|
| Products | | Column | rate | Coefficient of |
| Samples | Solution | volume | ml/min | decontamination |
| Ex. 1C | OSI + ¹³⁴Cs | 5 000 | 5 | 2 000 |
| Ex. 1D | OSI + ¹³⁴Cs | 10 000 | 5 | >6 000 |
| Ex. 1A | OSI + ¹³⁴Cs | 5 000 | 3 | >6 000 |
| Ex. 1B | OSI + ¹³⁴Cs | 2 000 | 1.5 | >6 000 |
| Ex. 1B | BF6 (¹³⁷Cs) | 15 000 | 10 | >6 000 |

The values listed in this table are only limit values as the reception limits of the device have been reached, with the exception of those obtained under batchwise conditions.

The product prepared under batchwise conditions has a coefficient of decontamination which is much lower than those of the products synthesized in a fluidized bed in accordance with the invention.

1. Process for the preparation of a composite solid material which fixes inorganic contaminants, based on metal hexacyanoferrate, comprising a solid support coated with a film of an anion-exchange polymer to which is fixed an insoluble metal hexacyanoferrate forming a thin layer, said process essentially comprising at least one step in which said solid support is brought into contact with at least one liquid reactant and at least one step in which washing is carried out, with a washing liquid, characterized in that all of the steps of the process are carried out continuously in one and the same receptacle, such as a column, in which the support forms a fluidized bed, the fluidization of which is provided by said at least one reactant or optional washing liquid.

2. Process according to claim 1, characterized in that the amount of metal hexacyanoferrate fixed is from 1 to 10% by weight with respect to the weight of the solid support.

3. Process according to claim 1, characterized in that the support is chosen from silica, alumina, titanium oxide, zirconium oxide, diatomaceous earth, zeolites and glasses.

4. Process according to any one of the preceding claims, characterized in that the support is provided in the form of particles, such as grains, beads or spheres; or of fibres.

5. Process according to claim 4, characterized in that the support is provided in the form of particles and has a particle size of 1 to 500 μm.

6. Process according to either one of claims 4 and 5, characterized in that the support has a specific surface of 10 to 500 m²/g.

7. Process according to any one of claims 4 to 6, characterized in that the support has a mean pore size of 100 to 1 000 Å.

8. Process according to claim 1, characterized in that said anion-exchange polymer results from an organic polymer, said organic polymer optionally having been provided with cationic groups.

9. Process according to claim 8, characterized in that said organic polymer is chosen from polyvinylimidazoles, copolymers of vinylimidazole with at least one other monomer, polyethyleneimines (PEI) and noncrosslinked polymers comprising, as anion-exchange groups, solely quaternary ammonium groups and not comprising primary, secondary and tertiary amine groups, such as a polybrene®.

10. Process according to any one of claims 1 to 9, characterized in that said metal hexacyanoferrate is chosen from copper hexacyanoferrate, cobalt hexacyanoferrate, zinc hexacyanoferrate, cadmium hexacyanoferrate, nickel hexacyanoferrate, iron hexacyanoferrate and mixed hexacyanoferrates relating to these salts.

11. Process according to any one of claims 1 to 10, comprising the following successive steps:
impregnation of a solid support with an aqueous solution of an anion-exchange polymer, in order to form a film of said polymer on said solid support;
washing with demineralized water;
impregnation of the solid support thus coated with a film of anion-exchange polymer, with an aqueous solution of alkali metal hexacyanoferrate;
washing with demineralized water said solid support coated with a film of anion-exchange polymer to which is fixed an alkali metal hexacyanoferrate;
addition of an aqueous solution of a metal salt to said coated solid support in order to form a composite solid material which fixes inorganic contaminants comprising the solid support coated with a film of anion-exchange polymer to which is fixed an insoluble metal hexacyanoferrate forming a thin layer;
washing with demineralized water.

12. Process according to claim 11, in which the anion-exchange polymer is chosen from noncrosslinked anion-exchange polymers comprising, as anion-exchange groups, solely quaternary ammonium groups and not comprising primary and secondary and tertiary amine groups and optionally polyethyleneimines (PEI).

13. Process according to claim 11, characterized in that the organic polymer solution is a solution in water, for example in demineralized water.

14. Process according to claim 11, characterized in that said alkali metal hexacyanoferrate is chosen from sodium hexacyanoferrate(II), sodium hexacyanoferrate(III), potassium hexacyanoferrate(II) and potassium hexacyanoferrate(III).

15. Process according to claim 11, characterized in that the aqueous solution of alkali metal hexacyanoferrate is a solution in pure demineralized water.

16. Process according to claim 11, characterized in that said metal salt is chosen from copper, cobalt, nickel, cadmium, zinc and iron salts.

17. Process according to claim 11, characterized in that the anion of said metal salt is chosen from nitrates, sulphates, chlorides and acetates.

18. Process for fixing at least one inorganic contaminant, such as a metal cation present in a solution, in which, first of all, a composite solid material which fixes inorganic contaminants, based on metal hexacyanoferrate, comprising a solid support coated with a film of an anion-exchange polymer to which is attached an insoluble metal hexacyanoferrate, is prepared by the process according to any one of claims 1 to 17, without a final drying step, and then said solution is brought continuously into contact with said composite solid material which fixes inorganic contaminants, in the same receptacle, such as a column, in which said material was prepared.

19. Process according to claim 18, in which said contacting operation is carried out by percolation of the solution through the composite solid material which fixes inorganic contaminants.

20. Process according to claim 18, in which the contacting operation is carried out in a fluidized bed formed by the composite solid material, the fluidization of which is provided by the solution comprising the inorganic contaminant.

21. Process according to claim 18, characterized in that said solution is an aqueous solution.

22. Process according to claim 18, characterized in that said solution is a process liquid or an industrial effluent.

23. Process according to claim 18, characterized in that said solution is chosen from liquids and effluents resulting from the nuclear industry and nuclear plants and activities employing radionuclides.

24. Process according to any one of claims 18 to 23, characterized in that said contaminant is present at a concentration of 0.1 picogram to 100 mg/l.

25. Process according to any one of claims 18 to 24, characterized in that said contaminant results from a metal or from a radioactive isotope of said metal.

26. Process according to claim 25, characterized in that said contaminant is chosen from anionic complexes, colloids and cations.

27. Process according to any one of claims 18 to 26, characterized in that said contaminant is an element chosen from Cs, Co, Ag, Ru, Fe and Tl and the isotopes of these.
